(19) United States
(12) Patent Application Publication
(10) Pub. No.: US 2007/0129090 A1
(43) Pub. Date: Jun. 7, 2007

(54) METHODS OF IMPLEMENTING AN OPERATION INTERFACE FOR INSTANT MESSAGES ON A PORTABLE COMMUNICATION DEVICE

(76) Inventor: Liang-Chern Tarn, Taipei (TW)

Correspondence Address: WILSON SONSINI GOODRICH & ROSATI, 650 PAGE MILL ROAD, PALO ALTO, CA, 94304-1050, US

(21) Appl. No.: 11/275,019

(22) Filed: Dec. 1, 2005

(51) Int. Cl. H04Q 7/20

(52) U.S. Cl. 455/466

(57) ABSTRACT

An operation interface for instant messages (IM) on a portable communication device is provided. In method of implementing such interfaces, the contacts or IM systems are organized into groups and can be switched by using a navigator key or predefined hotkeys. In addition, a counter can be set to record of the number of times an incoming message is received for each contact. The sequence order of contacts can be rearranged according to the counted values, and the most frequently receiving incoming message of contacts can be displayed on the screen of the device. Also, once the user receives an incoming message, the device can prompt the user with different audible or visual signals according selected attributes of the incoming message.

### BACKGROUND OF THE INVENTION

1. Field of the Invention

The present invention relates to methods of implementing an operation interface for instant messages, particularly to user interfaces for instant messages on portable communication devices, whereby users can identify contacts to incoming messages, search and access desired contacts, and/or automatically correct outgoing messages.

2. Description of the Related Art

Currently, some of the most popular instant message (IM) systems, such as MSN (Messenger, Microsoft Corporation) and Yahoo! Messenger (Yahoo! Inc.), support the ability of users to organize contacts into groups. FIG. 1 shows a conventional contact arrangement of an IM system on a computer or personal digital assistant (PDA). A user himself/herself can create any number of groups and name them for display on a computer or PDA screen 10, such as Family, Relatives, Friends, Colleagues, Neighbors, etc. The type of conventional IM interface generally exhibits groups and contacts in a hierarchical tree structure. A number of contacts are displayed on the screen within designated groups. In this way, it may be satisfactory for computer users to search a desired contact on the display screen by scrolling or navigating around the interface by pressing directional keys or tapping a scrolling bar 12.

These conventional IM systems generally arrange all contacts in alphabetic order and ASCII (American Standard Code for Information Interchange) order. However, this format is often meaningless for users because the contacts are recognized by some other designation and usually have associated nicknames that are displayed on the screen. Further, the most frequent contacts do not necessarily appear on the top of the displayed contact list. Therefore, the user often has difficultly in finding a desired contact rapidly.

Many other disadvantages exist in the conventional IM system interfaces. For example, IM client software for portable devices presently display contacts in a relatively disorganized manner. All contacts are provided in a single list displayed on the screen of portable device usually in some type of outline format with some indentation. Further, with respect to a general portable devices such as a handset device or cellular telephone, the user can only operate the interface by using key buttons, and it is very unfriendly and difficult for the user to search and target a desired contact entry. Moreover, a conventional IM system will also prompt the user with an audible sound and/or a small message window may pop-up when a message is incoming. But it is often difficult for a portable device to effectively show even smaller message windows on the limited screen of a portable device.

In current available IM systems, a user also can not easily create/edit a message before sending it out. While typing a message with a full size computer keyboard is relatively very easy, it is relatively excruciating and painful for a user to type messages on a portable device. The users can either type a message character-by-character by using key buttons of limited in size, by touch panel taping or other inconvenient ways adapted for text entry in portable devices. Furthermore, the user of a portable device often types wrong or misspelled words by following current input method with limited key buttons. There is a need for an improved IM interface that is organized and better designed for actual patterns of use for each individual.

### SUMMARY OF THE INVENTION

For solving the aforementioned problems, the present invention provides methods and devices for presenting and implementing operation interfaces for instant messages on portable communication devices. Various aspects of the invention herein can be appreciated individually or collectively to provide an effective user interface for managing and displaying instant messages on portable devices.

The present invention provides methods of implementing an operation interface for instant messages on a portable communication device, wherein the contacts are organized into multiple groups such as an active group or a non-active group.

Another embodiment of the invention provides a method of implementing an operation interface for instant messages on a portable communication device, wherein the user can change the groups by using a navigator key or predefined hotkeys, and the user can change the IM systems by predefined hotkeys.

Yet another embodiment of the invention is to provide a method of implementing an operation interface for instant messages on a portable communication device, wherein a counter is configured to track or count the number of times incoming messages are received for each contact, and to generate a sequence order for the contacts to be displayed by sorting the incoming messages received from each contact based on the record(ed) values of the counter. A sorting period can be defined in advance by a user to present messages in a defined order at selected time intervals. In a preferable alternate embodiment of the invention, contacts with greater or higher counter values, which represent the number of incoming messages for each, will be displayed on the top portion of a contact list within the operation interface or display screen of a portable communication device.

Another embodiment of the invention provides operation interfaces for instant messages on a portable communication device with audible or visual notification signals. For example, when a user receives an incoming message, the user may be prompted by a sound or audible signal such as a beep or a series of one or more tones. In addition, if the incoming message is sent by a contact within a designated (active) group, the user may be further prompted by flashing signal or icon within the screen of the device corresponding to the contact and/or the (active) group. In yet another embodiment of the invention, when an incoming message is sent by a (non-active) group member, the user may be prompted by flashing the icon corresponding to the (non-active) group or contact therein. These and other signals may be assigned for any designated contacts within active, non-active or other defined groups.

Still another embodiment of the invention provides methods of implementing an operation interface for instant messages on portable communication devices with spell checking capabilities. For example, when the IM system detects an outgoing message or one that is being edited, a spellcheck program resident in the memory of the device can be automatically activated as the message is created or when completed. Moreover, the invention also provides methods of implementing an operation interface for instant messages, wherein a user can scroll to a marquee on the operation interface in the display screen to show the nickname of a contact in the active group or other defined groups.

The graphical user interfaces and methods of implementing interfaces for instant messages on portable communication devices provided in accordance with the invention offer these and many other benefits which allow a user to easily identify contacts for incoming messages, rapidly searching and accessing desired contacts, and automatically correct an outgoing message. Other goals and advantages of the invention will be further appreciated and understood when considering the specification and drawings herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

To enable the objectives, the characteristics and the functions of the present invention to be further understood, the preferred embodiments of the present invention is to be described in detail below in cooperation with the attached drawing, and wherein:

FIG. 1 shows a conventional contact arrangement of IM system on a computer or PDA;

FIG. 2 shows a flowchart of a method of implementing an operation interface for instant messages on a portable communication device according to a first embodiment of the invention;

FIGS. 3A and 3B show an operation interface for instant messages on a portable communication device related to the first embodiment of the invention shown in FIG. 2;

FIG. 4 shows a flowchart of a method of implementing a user interface for instant messages on a portable communication device related to a second embodiment of the invention; and

FIGS. 5A and 5B show a user interface for instant messages on a portable communication device related to the second embodiment of the invention shown in FIG. 4.

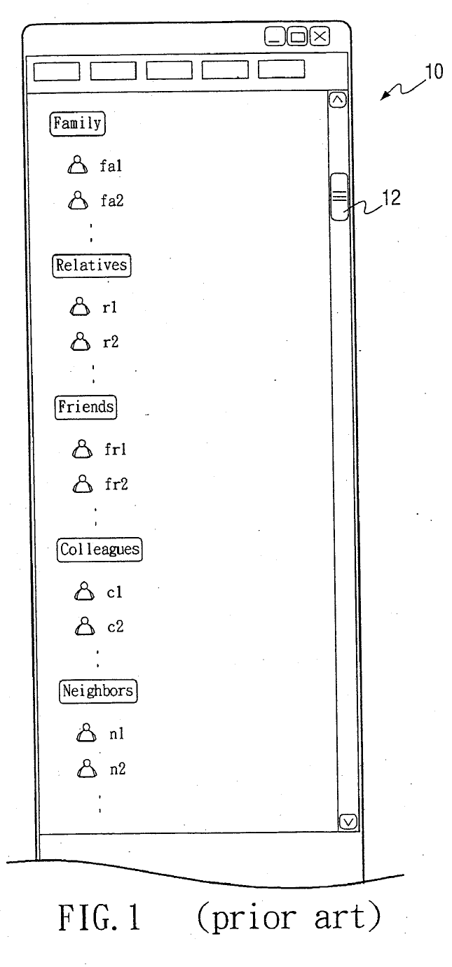

### DETAILED DESCRIPTION OF THE INVENTION

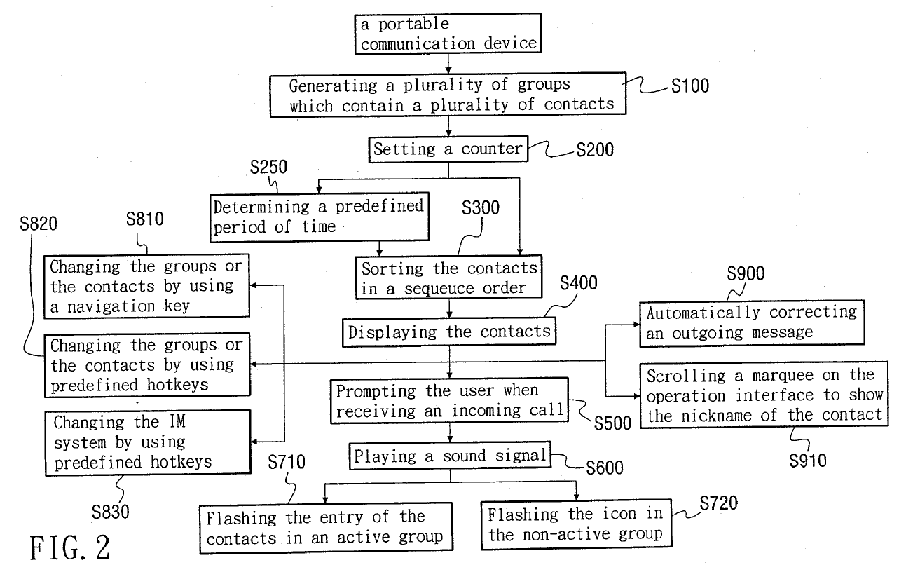

FIG. 2 shows a flowchart illustrating a method of implementing an operation interface for instant messages on a portable communication device according to a first embodiment of the present invention.

In the first embodiment, the portable communication device used in the invention includes a display screen, a navigation key, and several key buttons. This method may also include one or more of the following steps: a user generates several groups in the portable communication device, such as an active group and a non-active group, and wherein each group contains several contacts shown on the operation interface in the display screen (S100); a counter for each of the contacts that can be set to accumulate and count the number of times (1, 2, 3, 4. . . ) of incoming messages received and/or outgoing messages sent by a user for each corresponding contact (S200); sorting the contacts in a sequence order according to the counter (counted) values can be also performed (S300); the contacts on the operation interface in the display screen can also be shown according to the sorted contacts (S400). Before performing the step of sorting the contacts in a sequence order according to the counted values is preferably performed, the user can set a predefined period of time for sorting (S250). For example, the step of sorting the contacts can be initialized each day (eg, every 24 hours or other time interval) and respective counters can be reset to “0” value(s). The contacts with whom a user corresponds the most within each given time interval can be prioritized and appear in more prominent and visible portions of the user interface including the top of the screen or interface for a portable communication device.

In addition, once the user receives an incoming message, the portable communication device can prompt or notify the user (S500). This prompting may be a sound signal played by the portable communication device (S600). Further, the portable communication device can flash the entry (such as MSN or Yahoo entry) if the incoming message comes from a particular contact within an active group (S710), and/or flash the icon of a contact if the incoming message originates or comes from a member or contact of a non-active group (S720). Moreover, when the user needs to navigate to or find another group or contact within the user interface, the user may utilize a series of one or more navigation keys or predefined hotkeys on the portable communication device (S810 and S820). In some embodiments of the invention, the predefined hotkeys may be some of the button keys. Also, when the user wants to switch over to or change respective IM systems, these predefined hotkeys may be utilized by the user (S830) to change between the IM systems such as switching from a MSN to a Yahoo chat session.

In a preferable embodiment of the invention, a user interface may include a spellcheck button or option so the IM system can also automatically correct spelling and/or grammatical errors in an outgoing or draft message being prepared when the portable communication device detects that an outgoing message is being sent or edited (S900). Another embodiment of the invention provides added convenience allowing user to scroll to a marquee or icon on the operation interface to see or display the nickname of a relevant contact (S910).

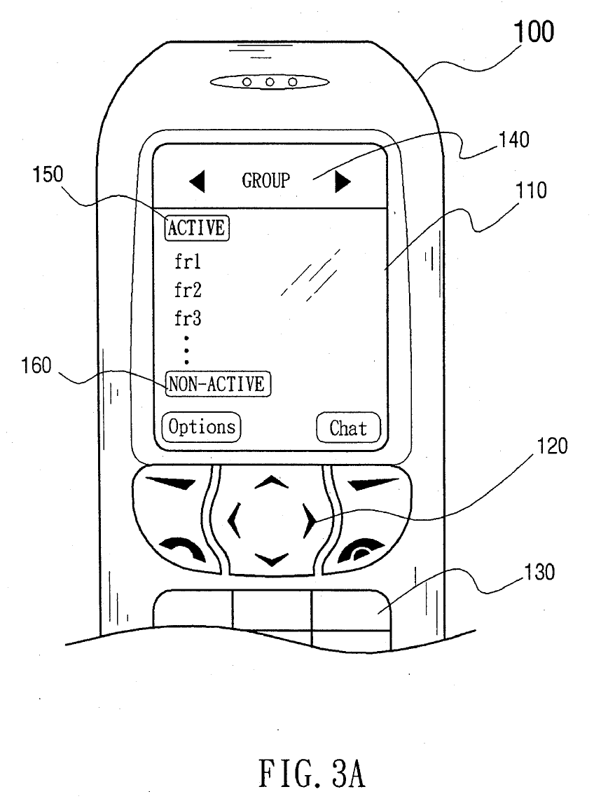

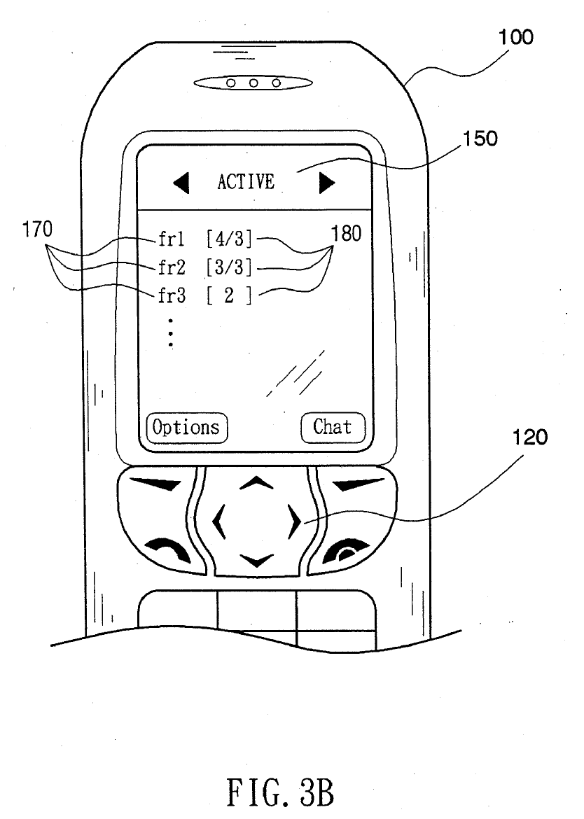

FIGS. 3A and 3B show the user (operation) interface for instant messages on a portable communication device implemented by a method similar to that described in FIG.2. The portable communication device 100 includes a display screen 110, navigation key 120, and several button keys 130.

In this embodiment of the invention, the interface on the display screen 110 includes a group 140 containing an active group 150 and a non-active group 160. Each of these or any other defined group provided herein may be identified with a corresponding icon or other graphical illustration on the display screen 110. The active group 150 may be defined to include all contacts designated to be in chatting status, whereby the user can easily switch to a different chat sessions within the active group 150 by choosing an entry shown in the operation interface, and wherein the active group 150 may further include multiple types of IM systems in the active group 150 that are designated as subgroups. On the other hand, the non-active group 160 may be defined to include contacts which are not designated on the displayed list to be in chatting status, wherein the non-active group 160 may also include various contacts from multiple types or different IM systems as subgroups illustrated within the interface. In an alternate embodiment of the invention, as shown in FIG. 3A, the user interface may include a limited or user configured hierarchical display of contacts within an active (or non-active group) together with icons to other non-active groups in the interface but without displaying their contents or relevant contacts therein which are not active and not immediately purposeful to the user. FIG. 3B also illustrates a series of one or more counters [x/y] for each of the contacts 170 (fr1, fr2, fr3. . . ) that can be set to accumulate and count the number of times of incoming messages (x) received and/or outgoing messages (y) sent by a user for each corresponding contact. The contacts can be sorted and displayed in a sequence order according to the counter (higher to lower “x”) values. This sequence order may be refreshed and reset by a user when desired at regularly scheduled intervals or defined time periods (eg, daily, weekly, etc) as desired. The sequence order for the displayed contacts may also be selected in a manner other than the counted values by a user.

In these kinds of an arrangements described above, the contacts stored within a portable device can be user organized in a practical and effective manner. All contacts are therefore not displayed unnecessarily in one list on the screen, and the user of the portable communication device 100 can also more easily search the contact through conveniently organized active, non-active or any other groups.

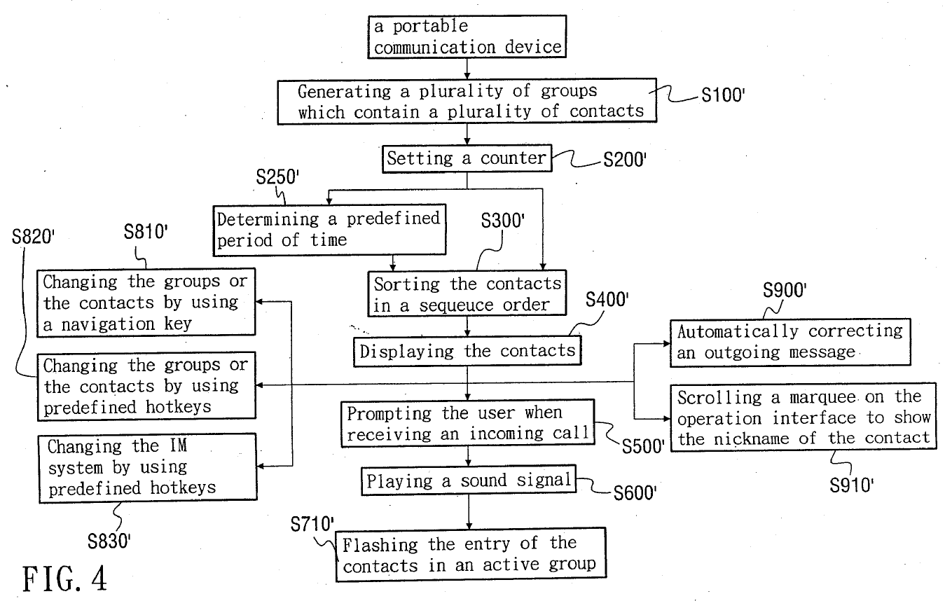

FIG. 4 shows a flowchart of other methods of implementing an operation interface for instant messages on a portable communication device according to a second embodiment of the invention.

In the second embodiment of the invention, the portable communication device used in the present invention includes a display screen, a navigation key, and several key buttons. This embodiment of the invention also includes the following steps: a user generates several groups in the portable communication device, such as an active group and a non-active group, and each group is containing several contacts on the operation interface in the display screen (S100′); a counter for the contacts is set to accumulate and count the number of times of receiving incoming messages or sending outgoing messages for each corresponding contact (S200′); sorting the contacts in a sequence order according to the counted values is performed (S300′); the contacts on the operation interface in the display screen according to the sorted contacts is displayed (S400′). Before the step of sorting the contacts in a sequence order according to the counted values is performed, the user can set a predefined period of time for sorting (S250′).

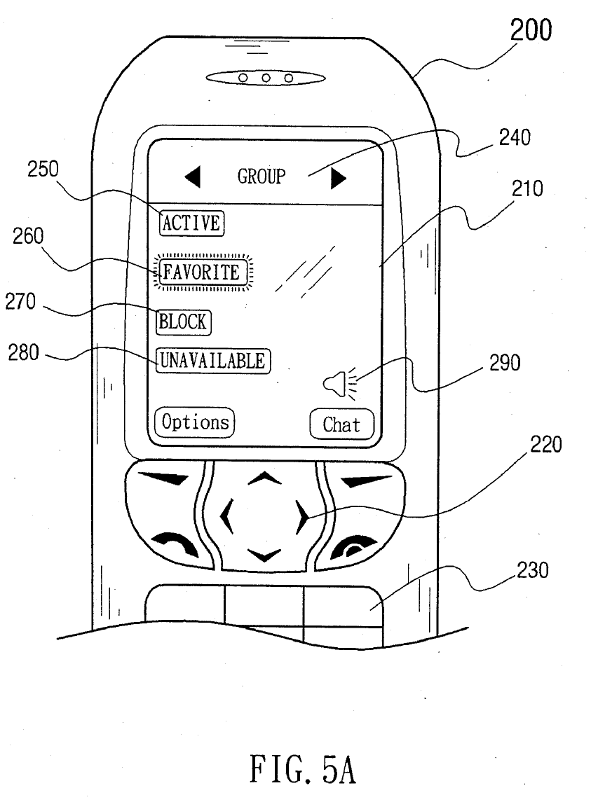

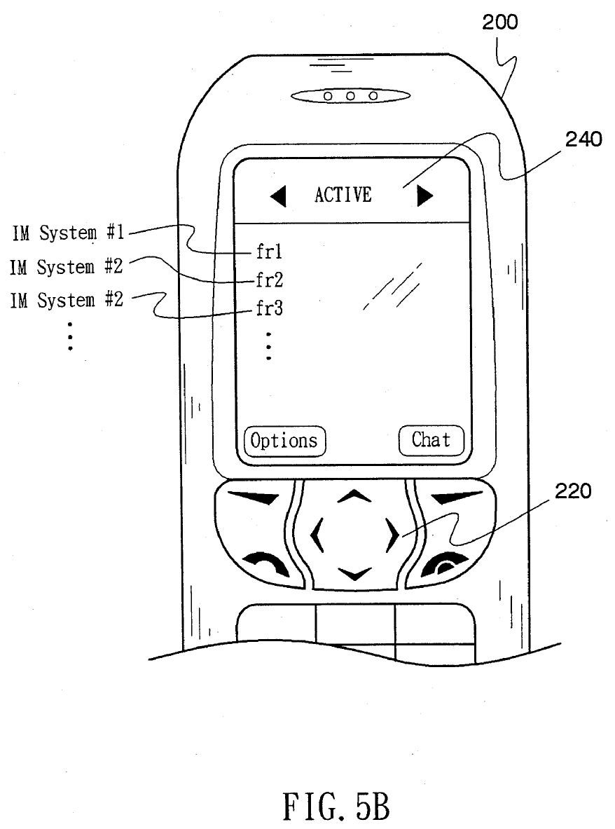

In addition, once the user receives an incoming message, the portable communication device can prompt the user for notifying (S500′). The prompting may be a sound signal (see FIG. 5A-290) played by the portable communication device (S600′). Further, the portable communication device can flash the entry of the contact (such as MSN or Yahoo entry) or its respective group if the incoming message comes from an active group (S710′) or favorite group (see FIG. 5A-260). Besides, when the user needs to find another group or contact, the user may utilize the navigation key or predefined hotkeys on the portable communication device (S810′ and S820′). The predefined hotkeys may be some of the button keys. Also, when the user wants to change the IM system, the predefined hotkeys may be utilized by the user to change between IM systems such as switching a MSN to Yahoo chat (S830′).

Furthermore, another embodiment of the invention can also can automatically correct spelling or grammar error of an outgoing message if the portable communication device detects that an outgoing message is edited (S900′), and more convenience may be added in that the user can scroll a marquee on the operation interface to see the nickname of the contact (S910′).

FIGS. 5A and 5B show an operation interface for instant messages on a portable communication device according to another embodiment of the invention as shown in FIG.4. The portable communication device 200 includes a display screen 210, navigation key 220, and several button keys 230. In this embodiment, the group 240 contains an active group 250, a favorite group 260, a blocked group 270, and an unavailable group 280.

The active group 250 can be defined as all the contacts in the chatting status, whereby the user can easily switch to a different chat sessions by choosing an entry in the operation interface, and wherein the active group 250 may add many IM systems into the active group 250 as subgroups, and the user may alternately switch between those IM subgroups in a single operation interface, i.e. the group “active group” collects various chatting IM subgroups. For example, if a user is chatting with one MSN chat and two Yahoo chats, there can be (3) three separate entries of chatting subgroups displayed within the interface under the active group 250 (see FIG. 5B). Each chatting subgroup may thus include users from different IM systems in accordance with this embodiment of the invention.

The favorite group 260 can be defined as all the contracts that are in the status of receiving the most incoming message or sending the most outgoing messages, wherein the favorite group 260 may also include various contacts from different IM systems as subgroups.

The blocked group 270 can be defined as all the contacts in the blocked status, whereby the user may review the blocking status and unlock specific contacts if needed lest the user forgets the blocking status of some contacts that the user may only want to block for a short period of time. The blocked group 270 may also include various contacts from different IM systems as subgroups.

The unavailable group 280 can be defined as all the contacts in the status of having no chatting record for a determined time period, wherein the user can set the collecting period to determine the “unavailable” status, and the unavailable group 280 may also include various contacts from different IM systems as subgroups.

In this type of described arrangement for the groups, the contacts therein can be categorized in a tree-structure organization of the groups, so the contacts are not all listed on the screen at the same time, and the user of the portable communication device 200 can also easy search the contact in a convenient tree-structure (hierarchical) organization.

The user interfaces and related methods herein for implementing an operation interface for instant messages on a portable communication device offer numerous advantages. For example, some embodiments provide a convenient structure organization for contacts, an easy operation of the navigator key, diversified indication of an incoming message, and automatic correction for an outgoing message. Therefore, these and other aspects of the invention provide interfaces for instant messages on a portable communication device to enable a user to easily identify the contact of an incoming message, to rapidly search and access the desired contact, and to correct any error in an outgoing message.

The embodiments described above are only to clarify the invention to enable the persons skilled in the art to understand, make, and use the invention but not to limit the scope of the present. Any equivalent modification or variation according to the spirit of the present invention disclosed herein is to be included within the scope of the present invention.

What is claimed is:

1. A method of implementing an operation interface for operating different instant message (IM) systems executed on a portable communication device, which has a display screen, a navigation key and a plurality of key buttons, comprising the following steps:
generating a plurality of groups containing a plurality of contacts on the operation interface in the display screen;
setting a counter for the contacts to accumulate the number of times of incoming messages are received or outgoing messages are sent corresponding to each contact;
sorting the contacts in a sequence order according to the counted value; and
displaying the contacts on the operation interface in the display screen according to the sorted contacts.

2. The method of claim 1, wherein the plurality of groups comprise an active group and a non-active group.

3. The method of claim 1, further comprising a step of prompting the user when receiving an incoming message.

4. The method of claim 3, wherein the step of prompting the user comprises a step of playing a sound signal.

5. The method of claim 3, wherein the step of prompting the user further comprises a step of flashing the entry of the contacts in an active group of the groups.

6. The method of claim 3, wherein the step of prompting the user further comprises a step of flashing the icon in the non-active group of the groups.

7. The method of claim 1, wherein the setting step further comprises a step of determining a predefined period of time for executing the sorting step.

8. The method of claim 1, further comprises a step of changing the groups or the contacts by using the navigation key.

9. The method of claim 1, further comprises a step of changing the groups or the contacts by using a plurality of predefined hotkeys of the key buttons.

10. The method of claim 1, further comprises a step of changing the IM systems by using a plurality of predefined hotkeys of the key buttons.

11. The method of claim 1, further comprises a step of automatically correcting an outgoing message sent by the user on the operation interface.

12. The method of claim 1, further comprises a step of scrolling a marquee on the operation interface in the display screen to show the nickname of a contact in the active group of the groups.

13. A method of implementing an operation interface for operating different Instant Message (IM) systems executed on a portable communication device, which has a display screen, a navigation key and a plurality of key buttons, comprising the following steps:
generating a plurality of predefined groups containing a plurality of contacts according to predefined statuses of the contacts on the operation interface in the display screen;
setting a counter for the each contact to accumulate the number of times of incoming messages are received corresponding to each contact;
sorting the contacts in a sequence order according to the counted value; and
displaying the contacts on the operation interface in the display screen according to the sorted contacts.

14. The method of claim 13, wherein the predefined groups comprises an active group including all the contacts in a chatting status.

15. The method of claim 13, wherein the predefined groups comprises a favorite group including all the contacts in a receiving status arranged according to the most incoming messages or most outgoing messages.

16. The method of claim 13, wherein the predefined groups comprises a blocked group including all the contacts in a blocked status.

17. The method of claim 13, wherein the predefined groups comprises an unavailable group including all the contacts in the status of having no chatting record in the determined time period.

18. The method of claim 13, further comprising a step of prompting the user when receiving the incoming message.

19. The method of claim 18, wherein the step of prompting the user comprises a step of playing a sound signal.

20. The method of claim 19, wherein the step of prompting the user further comprises a step of flashing the entry of the contacts in an active group of the groups.

21. The method of claim 13, wherein the setting step further comprises a step of determining a predefined period of time for executing the sorting step.

22. The method of claim 13, further comprises a step of changing the groups or the contacts by using a navigation key.

23. The method of claim 13, further comprises a step of changing the groups or the contacts by using a plurality of predefined hotkeys of the key buttons.

24. The method of claim 13, further comprises a step of changing the IM systems by using a plurality of predefined hotkeys of the key buttons.

25. The method of claim 13, further comprises a step of automatically correcting an outgoing message sent by the user on the operation interface.

26. The method of claim 13, further comprises a step of scrolling a marquee on the operation interface in the display screen to show the nickname of a contact in the active group of the groups.
